(19) United States
(12) Patent Application Publication
(10) Pub. No.: US 2014/0006116 A1
(43) Pub. Date: Jan. 2, 2014

(54) DIGITAL CUSTOMER CARD APPLICATION

(71) Applicant: Dahai Ren, Lincoln, MA (US)

(72) Inventor: Dahai Ren, Lincoln, MA (US)

(73) Assignee: VERIZON PATENT AND LICENSING INC., Basking Ridge, NJ (US)

(21) Appl. No.: 13/538,247

(22) Filed: Jun. 29, 2012

(51) Int. Cl. G06Q 30/02

(52) U.S. Cl. 705/14.3

(57) ABSTRACT

A method includes receiving, at a third party network location, a business profile from a business partner, wherein the business profile includes a customer incentive program identifier that identifies the business partner and a customer incentive program provided by the business partner. The business partner is included in a list of available retailers. The method also includes receiving, from a user device, customer profile information for a customer and a selected retailer from the list of available retailers. The method further includes storing a customer profile that includes the customer profile information in association with the selected retailer. The method includes sending a customer incentive program user identifier associated with the selected retailer to the user device. The user device is operable to present the customer incentive program user identifier to participate in a customer incentive program provided by the selected retailer.

### BACKGROUND INFORMATION

Cell phones and tablets are consumer electronic devices that are often associated with a single user. These devices may include touch displays with which the user may input information to the cell phone or tablet. The touch display may protect access to the user device with a security feature, such as a required password.

Rewards cards are extensively used by retailers in order to track spending patterns of customers and present targeted advertisements to the customers. Customers are often required to submit written application forms to apply for the rewards cards.

### BRIEF DESCRIPTION OF THE DRAWINGS

FIG. 1 is a diagram illustrating a first exemplary environment according to an implementation described herein;

FIG. 2 is a diagram of an exemplary device in which methods and systems described herein may be implemented;

FIG. 3 is a diagram of an exemplary device displaying a graphical user interface (GUI) associated with a digital card application;

FIG. 4 is a diagram illustrating an exemplary functional block diagram of a customer incentive management system;

FIG. 5 is a table illustrating a customer address record and associated information;

FIG. 6 is a diagram illustrating a second exemplary environment according to an implementation described herein;

FIG. 7 is a diagram illustrating exemplary components of a device that may be included in one or more components of FIGS. 1, 2, 3, 4 and/or 6;

FIG. 8 is a flowchart of an exemplary process for providing support for a customer incentive management system; and

FIG. 9 is a flowchart of an exemplary process for implementing a digital customer card application in association with a user device.

### DETAILED DESCRIPTION OF PREFERRED EMBODIMENTS

The following detailed description refers to the accompanying drawings. The same reference numbers in different drawings identify the same or similar elements.

Embodiments described herein relate to devices, methods, and systems for providing a cloud based customer incentive program. The cloud based customer incentive program includes a digital customer card application and a supporting digital portal associated with the customer incentive program. Embodiments described remove a requirement for customers to carry physical cards and provide a capability for retailers to accurately track residence addresses of customers in association with the customer incentive program. An administrator/service provider may provide targeted advertisements based on the residence addresses and other information associated with the customer.

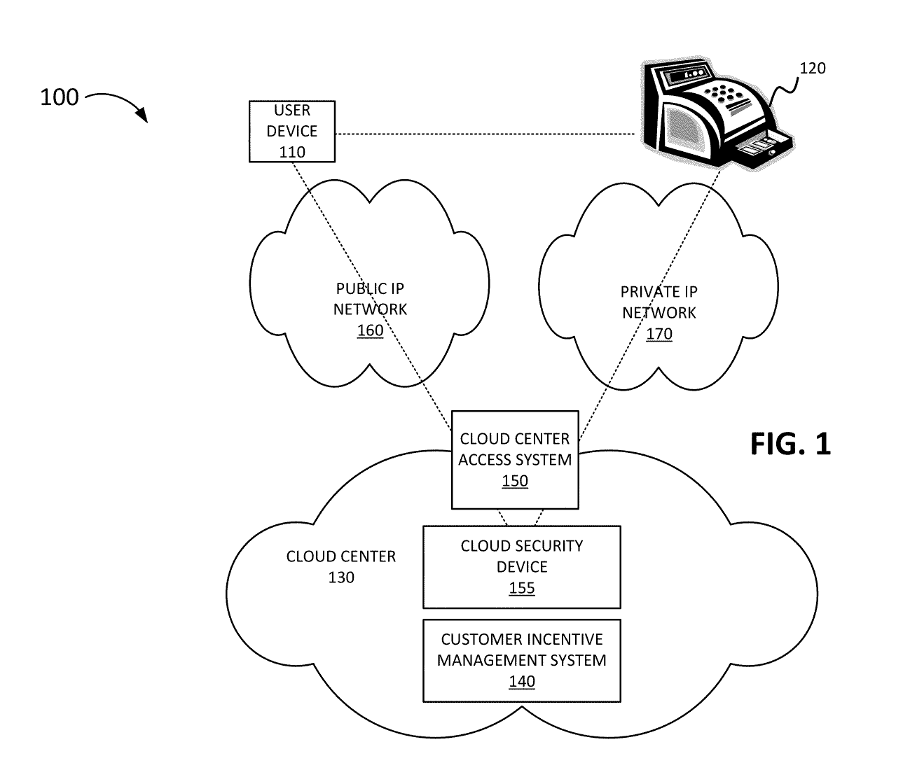

FIG. 1 is a diagram of an environment 100 in which the systems and/or methods described herein may be implemented. As shown in FIG. 1A, environment 100 may include a user device 110, a business device 120, a cloud center 130, a public Internet protocol (IP) network 160, and a private IP network 170. Cloud center 130 may include a customer incentive management system 140, a cloud center access system 150, and a cloud security device 155. While FIG. 1 shows a single user device 110, a single business device 120, a single cloud center 130, a single customer incentive management system 140, a single cloud center access system 150, a single cloud security device 155, a single public IP network 160, and a single private IP network 170 for illustrative purposes, in practice, environment 100 may include additional user devices 110, business devices 120, multiple cloud centers 130, multiple cloud center access systems 150, multiple cloud security devices 155, multiple public IP network 160, or multiple private IP networks 170.

User device 110 may enable a user (e.g., a customer (or prospective customer) of a business/enterprise) to view video content or interact with business device 120, another user device 110 and/or a video display device (e.g., a set-top box and/or television). User device 110 may include, for example, a personal communications system (PCS) terminal (e.g., a smartphone that may combine a cellular radiotelephone with data processing and data communications capabilities), a tablet computer, a personal computer, a laptop computer, a gaming console, an Internet television, or other types of computation or communication devices. User device 110 may include the capability to generate a signal, an electronic image or other electronic information that may be used to identify a customer in association with a particular account. User device 110 may interact with customer incentive management system 140 to provide customer profile information to customer incentive management system 140, such as described herein.

Business device 120 may include a capability to receive information from user device 110 that may be used to identify a user associated with user device 110 in association with a customer incentive program. Business device 120 may enable a business user (e.g., a store clerk or other personnel that interacts with customers) to receive information associated with a customer from user device 110 in the course of a retail transaction (e.g., when a customer purchases a product associated with a business (or businesses)). Business device 120 may include, for example, a point of sale system, a barcode reader, an optical scanner, etc. Additionally, business device 120 may interact with back end support systems, such as customer incentive management system 140, to provide customer incentive and advertising applications, such as described herein.

Cloud center 130 may include one or more server devices and/or storage devices, which provide cloud services for customers. The cloud services may include computing and/or storage capacity as a service over a network. The one or more server devices and/or storage devices may connect to cloud center access system 150 via a connection, such as a Layer 2 connection or a Layer 3 connection. Cloud services provided by cloud center 130 may include, for example, computing as a service, cloud storage, cloud based support for customer relationship management as described below, a hosted voice-over-Internet Protocol (VoIP) service, a Network Address Translation (NAT) service, a Virtual Private Network (VPN) service, a Distributed Denial of Service (DDOS) detection and/or mitigation service, a firewall service, an Intrusion Detection and Prevention System (IDPS), an email filtering service, a filtering service for a particular web site, a load balancing service, a video distribution service, a lawful intercept service on behalf of a law enforcement entity, and/or any other type of service that be provided by a cloud center, such as a customer incentive management service described with respect to customer incentive management system 140.

Customer incentive management system 140 may provide support for a customer incentive program and associated advertising applications. The customer incentive program may include providing incentives in association with purchases by the customer. In one instance, customer incentive management system 140 may support a customer rewards program, such as described below, and may include a database of addresses associated with customers.

Cloud center access system 150 may include one or more devices that connect cloud center 130 to public IP network 160, and/or to private IP network 170. Cloud center access system 150 may facilitate electronic communication between user device 110, business device 120 and/or customer incentive management system 140.

Cloud security device 155 may include one or more devices that provide one or more security services for user devices 110. For example, cloud security device 155 may form a repository for adaptive security information associated with user device 110, as described below.

Public IP network 160 may include a public IP packet-switched network, a circuit-switched network, or a combination thereof. For example, public IP network 160 may include a local area network (LAN), a wide area network (WAN), a metropolitan area network (MAN), an ad hoc network, an intranet, a fiber optic-based network (e.g., a fiber optic service network), a wireless network (e.g., a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of thereof), and/or a combination of these or other types of networks.

Private IP network 170 may include a private IP packet-switched network, a private circuit-switched network, a wireless network, or a combination thereof.

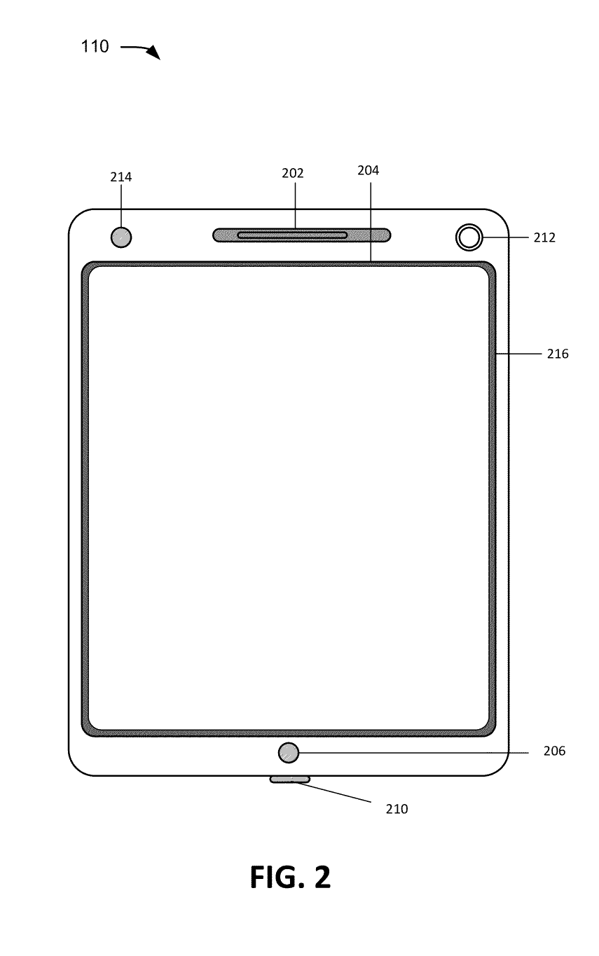

FIG. 2 is a diagram of an exemplary user device 110 in which methods and systems described herein may be implemented. Although illustrated as a tablet or touch screen device, user device 110 may include any type of computational or communication device.

As shown in FIG. 2, user device 110 may include a speaker 202, a touchscreen display 204, control button 206, a microphone 210, sensors 212, a front camera 214, and a housing 216. Although user device 110 is shown with particular components and a particular configuration, user device 110 may include fewer, more or different components, such as additional sensors, input devices, and may include associated devices (e.g., a stylus) etc.

Speaker 202 may provide audible information to a user of user device 110.

Display 204 may provide visual information to the user, such as an image of a caller, video images, or pictures. In addition, display 204 may include a touchscreen for providing input to device 110. Display 204 may provide hardware/software to detect the coordinates of an area that is touched by a user. For example, display 204 may include a display panel, such as a liquid crystal display (LCD), organic light-emitting diode (OLED) display, and/or another type of display that is capable of providing images to a viewer. Display 204 may include a transparent panel/surface for locating the position of a finger or an object (e.g., stylus) when the finger/object is touching or is close to display 204.

Control button 206 may permit the user to interact with user device 110 to cause user device 110 to perform one or more operations, such as place or receive a telephone call, input data to user device 110, manipulate user interface elements, etc. In some implementations, control button 206 may include a telephone keypad (not shown) or an alphanumeric keyboard. Microphone 210 may receive audible information from the user. Sensors 212 may collect and provide, to device 110, information (e.g., acoustic, infrared, etc.) that is used to aid the user in capturing images or in providing other types of information (e.g., a distance between a user and user device 110). Front camera 214 may enable a user to view, capture and store images (e.g., pictures, video clips) of a subject in front of user device 110. Housing 216 may provide a casing for components of user device 110 and may protect the components from outside elements.

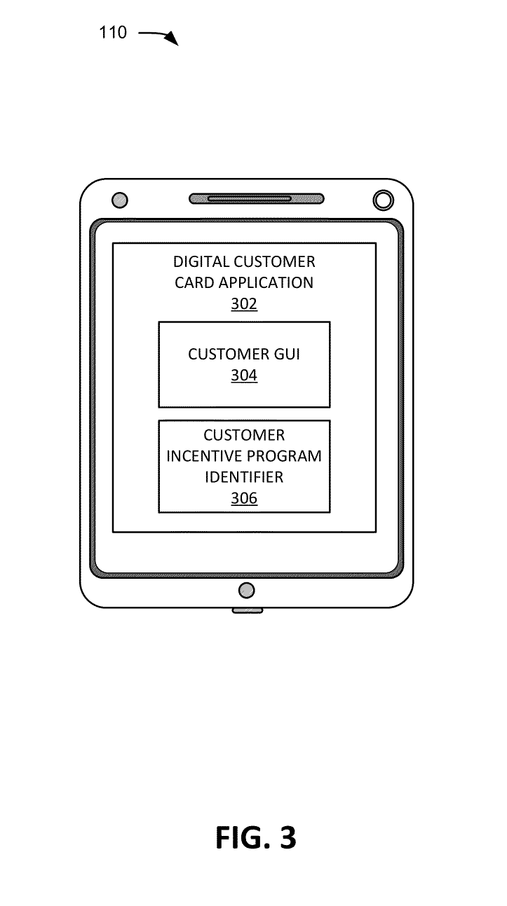

FIG. 3 illustrates an implementation of user device 110 that includes a digital customer card application 302 that may be executed to provide information that identifies a user associated with user device 110.

As shown in FIG. 3, user device 110 may include digital customer card application 302 that provides a customer graphical user interface (GUI) 304 and client-side support on user device 110 (associated with a particular customer) for a customer incentive program. Customer GUI 304 may include an input/output interface associated with the customer incentive program. User device 110 may include digital customer card application 302 as preinstalled machine-readable instructions (e.g., provided by a manufacturer of user device 110). Alternatively, users may download digital customer card application 302 from customer incentive management system 140 or an associated database.

A user may provide an initial customer profile to customer incentive management system 140 via customer GUI 304. For example, if the user has not previously registered with customer incentive management system 140, digital customer card application 302 may prompt the user to provide required information to create a customer profile (e.g., by typing the information into customer GUI 304). The contact information may include a name, a mailing address, an email address, a telephone number, and other associated information.

Digital customer card application 302 may provide the capability for a user to participate in a customer incentive program for one or more businesses (e.g., the user may select to enroll in a customer incentive program for different businesses, such as retail clothing, grocery shopping, consumer electronics, etc.). For example, digital customer card application 302 may allow the user to browse a list of retailers who are participants (i.e., business partners that provide customer incentives in association with digital customer card application 302) of customer incentive program within the GUI provided by digital customer card application 302. The user may select one or more listed retailers and provide an input indicating that the user is “signing up” for a customer incentive program in association with the selected retailers (e.g., based on shopping habits, etc. of the user). Digital customer card application 302 may store the selected retailers in a list of selected retailers associated with the user (e.g., “my rewards card list”).

Digital customer card application 302 may provide a customer incentive program identifier 306 associated with each selected retailer in response to a “sign up” by the user for the customer incentive program provided by the selected retailer. Customer incentive program identifier 306 may include a logo/insignia/image associated with the customer incentive program for each particular retailer (e.g., a rewards card image, not shown) and a unique identifier, such as a barcode, which identifies the customer in association with the customer incentive program. Digital customer card application 302 may retrieve customer incentive program identifier 306 from customer incentive management system 140. Digital customer card application 302 may include a capability to provide customer incentive program identifier 306 to a business device 120 (e.g., user device 110 may display a customer incentive program identifier 306 if the user selects the retailer).

The contact information of the user may be uploaded from user device 110 via a digital portal and added as a customer record of the retailer when the user adds the retailer into the list of selected retailers. The user may add many retailers into the list of selected retailers, with the customer profile provided to each of the selected retailers. The list of selected retailers may be stored in a digital wallet application on user device 110.

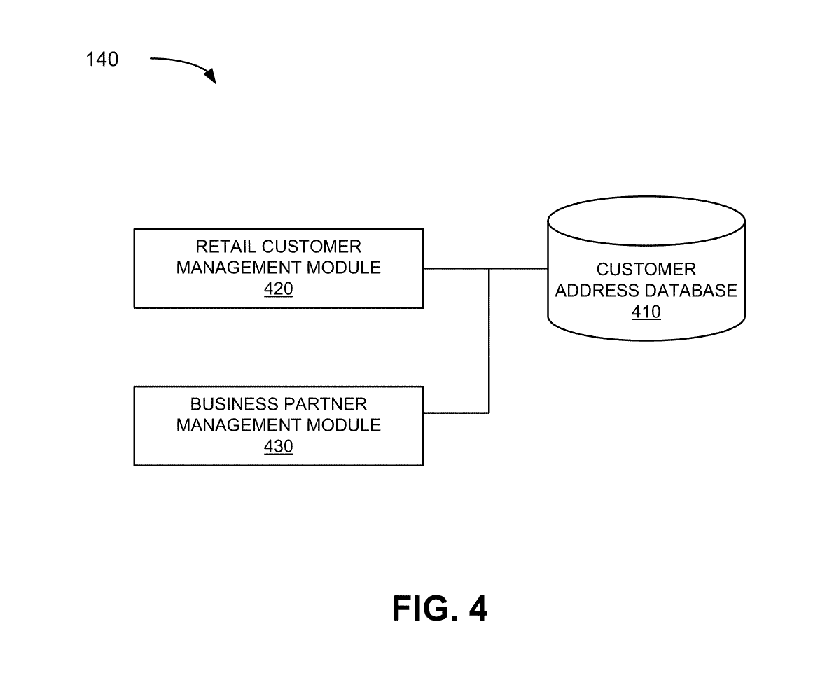

If the user updates his/her contact information by inputting changed contact information into customer GUI 304 (of digital customer card application 302) at user device 110, digital customer card application 302 may notify customer incentive management system 140 about the update. As described below with respect to FIG. 4 and customer incentive management system 140, the user's contact information (and corresponding customer profile) may be updated by customer incentive management system 140.

The user may gather items that qualify for the customer incentive program at a retail location (i.e., “in store” at a mall, supermarket, chain store, etc.) and present the items to a cashier/clerk (i.e., check out the items). The user may select the retailer from the list of selected retailers in digital customer card application 302. The user may present customer incentive program identifier 306 on user device 110 and allow the cashier to scan (e.g., with a barcode reader associated with business device 120, not shown in FIG. 3) customer incentive program identifier 306 on user device 110. Business device 120 may verify customer incentive program identifier 306 based on locally stored information (i.e., a particular type incentive program identifier 306 may correspond to a particular discount), or by sending (encrypted) information extracted from customer program identifier 306 to customer incentive management system 140, which may reply with customer incentive information specific to the particular customer.

According to one implementation, digital customer card application 302 may retrieve saved Wi-Fi network access points associated with a user (home) network from user device 110. The user may be asked by digital customer card application 302 if he/she is willing to identify home Wi-Fi access point from the list of saved access points and to add a media access control (MAC) address of home Wi-Fi router as additional contact information associated with the user. If the user agrees to terms and condition provided by digital customer card application 302, the user's home router MAC address may be submitted as part of the contact information to customer incentive management system 140 via a digital portal. The retailer may use the MAC address to target advertisements to customers that have submitted their MAC addresses when customers visit retailer websites (i.e., customers may be identified without logging on to the retailer website).

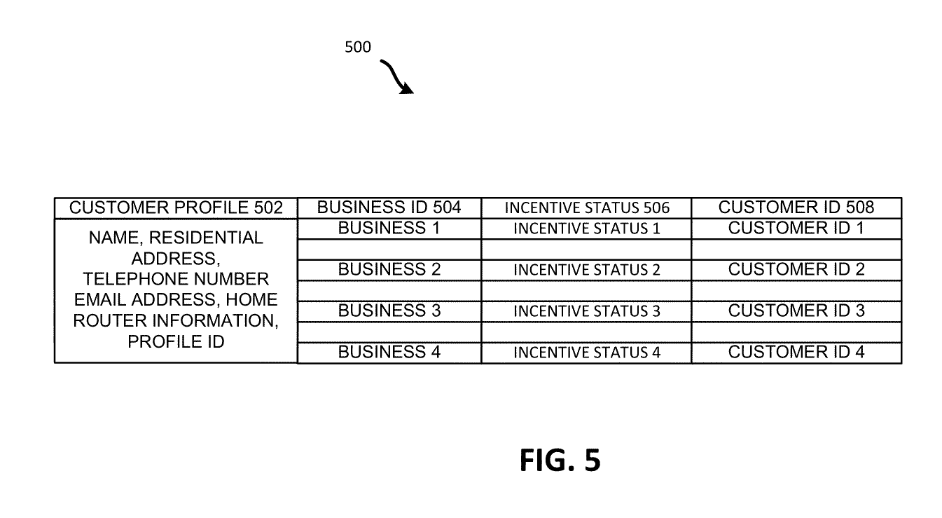

FIG. 4 is a diagram of exemplary functional components of customer incentive management system 140. As shown in FIG. 4, customer incentive management system 140 may include a customer address database 410, a retail customer management module 420 and a business partner module 430. Customer incentive management system 140 is described with respect to FIG. 5 and customer address table 500. The particular arrangement and number of components of customer incentive management system 140 as shown in FIG. 4 are illustrated for simplicity.

Customer address database 410 may include records for each retail user associated with customer incentive management system 140. The retail users may be users that have a particular customer profile. The records may include information as shown in customer address table 500 (FIG. 5).

As shown in FIG. 5, each customer record may be associated with a single customer (e.g., a particular user or a group, family, business enterprise, etc.). The record may include a customer profile 502 of the customer. Customer profile 502 may include a name, a residential address, a telephone number, an email address, and home router information for the user.

Business ID 504 may include information associated with a particular business (e.g. a listed retailer, such as “Viking Hats”). For example, business ID 504 may include an identifier for each retailer (shown as business 1, business 2, business 3, and business 4) with which the user has “signed up” for a customer incentive program.

Incentive status 506 may include a status of the user with regard to earning incentives associated with each business for the retail customer. For example, incentive status 506 may include a number of qualifying purchases that the retail customer has made, dollar amount of purchases, etc., in association with a particular business (e.g., incentive status 1 associated with business 1, incentive status 2 associated with business 2, etc.). Incentive status may also include a number of available rewards.

Customer ID 508 may include a barcode or other signal/identifier associated with the customer that may be transmitted/displayed by the customer to indicate that the customer is a participant in customer incentive program. For example, customer ID 508 may include a digital image associated with the customer incentive program, the customer and/or the retailer. Customer ID 508 may include information indicating different levels of a customer incentive program associated with the user. For example, customer ID 508 may include a color coded scheme corresponding to different percentage discounts (a blue image correspond to a ten percent discount, a yellow image to a twenty percent discount, a green image to a thirty percent discount, etc.). Customer ID 508 may include a customer ID 508 (e.g., customer ID 1. customer ID 2, etc.) that may each be associated with a single retailer. In another example, customer ID 508 may indicate different levels of privileges associated with the customer (e.g., preferred access to particular products, etc.).

Customer address database 410 may receive initial customer profiles and update the customer profiles based on information received from retail customers, as described with respect to retail customer management module 420, and information received from business partners, as described with respect to business partner module 430.

Retail customer management module 420 may include an application that may support a digital portal that the customer (using user device 110 or similar device) may access to enroll in (or update information for) a customer incentive program associated with a particular retailer. Retail customer management module 420 may receive customer profiles and store the customer profiles in customer address database 410. According to one example, retail customer management module 420 may access customer address database 410, determine an updated incentive status and provide the updated incentive status to user device 110. For example, retail customer management module 420 may send an alert to user device 110 indicating that the user has been upgraded to a different level in the customer incentive program (e.g., the customer may have higher percentage discounts or be eligible for additional services, etc.). Retail customer management module 420 may send a new customer ID 508 (e.g., a platinum colored rewards card image to replace a previous customer ID 508) and associated information indicating that the customer is eligible for a higher reward based on qualifying purchases.

Business partner module 430 may include an application that may support interaction with a business enterprise application for each of the listed retailers. For example, business partner module 430 may provide support for an interface (i.e., a digital portal) that receives a business profile from a business party (e.g., via a cloud supported application). The business partner may upload a business profile to customer incentive management system 140, including images, video, and other data associated with the business partner (e.g., a logo for the business partner and/or an incentive program provided by the business partner). Business partner module 430 may also receive information related to a current incentive status 506 associated with each customer (e.g., when a clerk “rings up” a qualified purchase on business device 120). Business partner module 430 may update current incentive status 506 in customer address database 410.

Business partner module 430 may enable retailers to receive updates to contact information from their customers directly and efficiently. For example, if the customer updates their contact information in customer address database 410 (via a digital portal provided at user device 110), business partner module 430 may “push” (i.e., upload) the updated contact information to a designated business enterprise application. Business partner module 430 may increase an accuracy associated with targeted advertisements. The updated contact information may allow retailers to send targeted advertisements to customers via emails and/or direct mail.

Business partner module 430 may provide the user's home router MAC address as part of the contact information to business enterprise application. The business enterprise application (or associated application developers) may apply the collection of data mapping between home address and home router MAC address for location based services. For example, the retailer may target specials that are relevant to a particular geographic location to devices associated with home router MAC addresses that are mapped to residence addresses that include a particular range of zip codes.

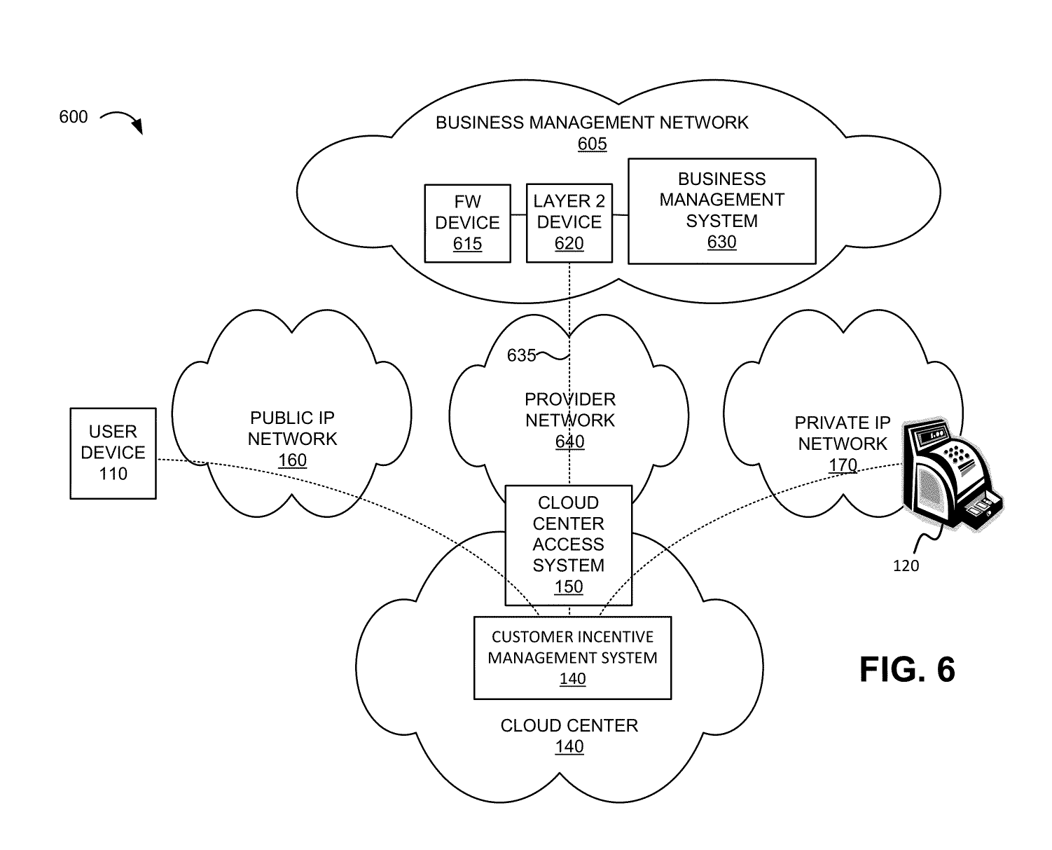

FIG. 6 is a diagram of an environment 600 in which the systems and/or methods described herein may be implemented. Environment 600 illustrates an implementation in which customer incentive management services for a business management network is provided via a cloud based system. As shown in FIG. 6, environment 600 may include user device 110, business device 120, cloud center 130, customer incentive management system 140, cloud center access system 150, public IP network 160, and private IP network 170, which function similarly as described with respect to FIG. 1 and environment 100. Additionally, environment 600 may include a business management network 605 and a provider network 640. While FIG. 6 shows a single business management network 605, a single provider network 640, a single cloud center 130, a single customer incentive management system 140, a single cloud center access system 150, a single public IP network 160, and a single private IP network 170 for illustrative purposes, in practice, environment 600 may include multiple business management networks 605, multiple provider networks 640, multiple cloud centers 130, multiple cloud center access systems 150, multiple public IP network 160, or multiple private IP networks 170.

Business management network 605 may include a LAN (and or WAN) and other devices/systems associated with managing particular aspects of a business. For example, business management network may include back-end systems that support business processes for a retailer, including sales and advertising, administrative, etc. Business management network 605 may manage business processes for distributed locations in a business organization (e.g., business network may be a “central office” that provides support for business devices 120 at retail locations). Business management network 605 may include a firewall (FW) device 615, a Layer 2 device 620, and a business management system 630.

Business management network 605 may include a Layer 2 network that is protected by firewall device 615. FW device 615 may perform firewall functions for the secure network (or sub-network) associated with business management network 605. Business management network 605 may also include a Layer 2 network that is not protected by firewall device 615. The unprotected portion of business management network 605 may include a demilitarized zone (DMZ) that includes public server devices that may be accessed over public IP network 160.

Layer 2 device 620 may include any device capable of processing and forwarding data at the data link layer. For example, Layer 2 device 620 may include a switch, a multi-port bridge, a Layer 2 firewall, or another type of Layer 2 device. Layer 2 device 620 may receive a data unit at a particular input port, may determine a particular output port for the data unit, and may forward the data unit via the output port.

Business management system 630 may include a system that determines and manages a customer incentive program in association with customer incentive management system 140. Business management system 630 may apply an incentive protocol. The incentive protocol identifies a process for assigning rewards based on the customer incentive program. For example, business management system 630 may identify applicable points earned in association with particular purchases by a user and customer incentive management system 140 may apply the applicable points to purchases by each customer. Alternatively, business management system 630 may send updates to information associated with all customers, or a particular customer to customer incentive management system 140, which may apply the incentive protocol. Business management system 630 may also receive updated contact information (and other information related to the customer incentive program) from customer incentive management system 140.

Provider network 640 may include a Layer 2 network, such as an Ethernet network, that may provide a Layer 2 connection between Layer 2 device 620 and cloud center access system 150 via Layer 2 connection 635.

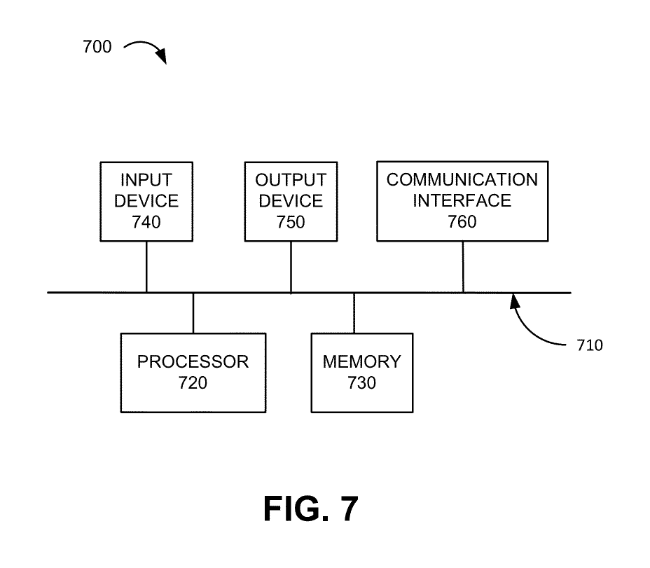

FIG. 7 is a diagram of exemplary components of a device 700 that may correspond to devices implementing any one of devices described with respect to FIGS. 1-6, such as user devices 110, cloud center 130, cloud center access system 150, cloud security device 155, public IP network 160, private IP network 170, FW device 615, layer 2 device 620, and business management system 630. Each of the devices (or systems) may include one or more devices 700. As shown in FIG. 7, device 700 may include a bus 710, a processor 720, a memory 730, an input device 740, an output device 750, and a communication interface 760.

Bus 710 may permit communication among the components of device 700. Processor 720 may include one or more processors or microprocessors that interpret and execute instructions. In other implementations, processor 720 may be implemented as or include one or more application specific integrated circuits (ASICs), field programmable gate arrays (FPGAs), or the like.

Memory 730 may include a random access memory (RAM) or another type of dynamic storage device that stores information and instructions for execution by processor 720, a read only memory (ROM) or another type of static storage device that stores static information and instructions for the processor 720, and/or some other type of magnetic or optical recording medium and its corresponding drive for storing information and/or instructions.

Input device 740 may include a device that permits an operator to input information to device 700, such as a keyboard, a keypad, a mouse, a pen, a microphone, one or more biometric mechanisms, and the like. Output device 750 may include a device that outputs information to the operator, such as a display, a speaker, etc.

Communication interface 760 may include a transceiver that enables device 700 to communicate with other devices and/or systems. For example, communication interface 760 may include mechanisms for communicating with other devices, such as other devices of environments 100 or 600.

As described herein, device 700 may perform certain operations in response to processor 720 executing machine-readable instructions contained in a computer-readable medium, such as memory 730. A computer-readable medium may include a non-transitory memory device. A memory device may include space within a single physical memory device or spread across multiple physical memory devices. The machine-readable instructions may be read into memory 730 from another computer-readable medium or from another device via communication interface 760. The machine-readable instructions contained in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and machine-readable instructions.

Although FIG. 7 shows exemplary components of device 700, in other implementations, device 700 may include fewer components, different components, differently arranged components, or additional components than those depicted in FIG. 7. As an example, in some implementations, input device 740 and/or output device 750 may not be implemented in device 700. In these situations, device 700 may be a “headless” device that does not explicitly include an input or an output device. Alternatively, or additionally, one or more components of device 700 may perform one or more other tasks described as being performed by one or more other components of device 700.

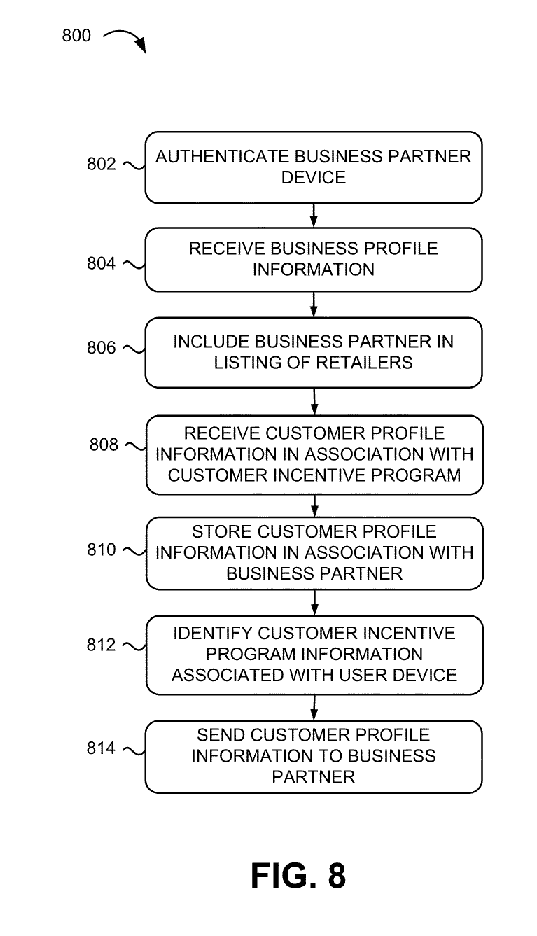

FIG. 8 is a flowchart of an exemplary process for implementing a customer incentive management service according to an implementation described herein. In one implementation, the process of FIG. 8 may be performed by customer incentive management system 140. In other implementations, some or all of the process of FIG. 8 may be performed by another device or a group of devices separate from customer incentive management system 140 and/or including customer incentive management system 140.

As shown in FIG. 8, customer incentive management system 140 may authenticate a business partner device (block 802). For example, customer incentive management system 140 may authenticate the business partner device in response to a request via a digital portal to upload a business profile to customer incentive management system 140 (i.e., a request for customer incentive management system 140 to receive the business profile). The digital portal may include encryption and other security measures to ensure the validity of the entity associated with the business partner device.

Customer incentive management system 140 may receive business profile information (block 804). The business profile information may identify the business partner and the particular customer incentive program (e.g., customer incentive program identifier 306, brand images for the business partner and/or the business partner's customer incentive program, etc.).

According to an implementation, a user (e.g., a customer) may upload business profile information for a prospective business partner. The user may upload an image based on a digital picture (or pictures, including front and back) of a physical rewards card to customer incentive management system 140. The user may also capture an image of a barcode or barcode information using a camera associated with user device 110. Customer incentive management system 140 may manage a customer incentive program based on the prospective business partner.

Customer incentive management system 140 may include the business partner in a digital listing of available retailers that are participating in customer incentive programs in association with customer incentive management system 140 (block 806). The listing may provide a customer the capability, via a GUI on user device 110, for a user to select the business partner (or other listed retailers) and enroll in a customer incentive program in association with the business partner.

Customer incentive management system 140 may receive the information via an application programming interface (API). User device 110 may provide a digital interface for a customer to sign up for the customer incentive program in association with retailers (i.e., business partners) that the customer may select from the digital listing. The user may sign up for the customer incentive program by providing required information at the interface and indicating one or more of the selected retailers.

At block 808, customer incentive management system 140 may receive customer profile information in association with the business partner's customer incentive program. For example, when a customer signs up for a customer incentive program an initial customer profile may be created, such as described with respect to FIG. 5 and customer address table 500.

Customer incentive management system 140 may store the customer profile information in association with the business partner's customer incentive program (block 810). Multiple retailers may be mapped to a particular customer profile based on the selection by the customer of each of the multiple retailers.

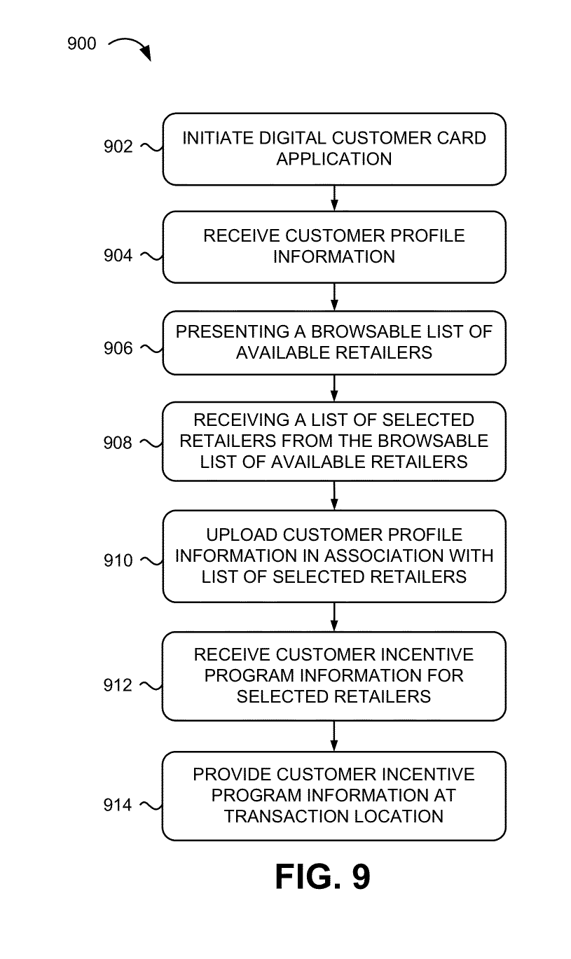

At block 812, customer incentive management system 140 may identify that customer incentive program information is associated with user device 110 and the selected retailers. For example, customer incentive management system 140 may send customer incentive program information (corresponding to each selected retailer) to user device 110 in response to the user signing up (block 808) for the customer incentive program, such as described with respect to FIG. 9 and process 900. The customer incentive program information may include a customer barcode, digital images associated with the selected retailer and/or the customer incentive program, and terms and conditions of the customer incentive program.

Customer incentive management system 140 may send the customer profile information to each of the business partners, for example using business partner contact information included in the business profile information (block 814). Customer incentive management system 140 may send updates to the business partner device based on updates to customer profiles received from user devices 110.

FIG. 9 is a flowchart of an exemplary process for implementing a customer incentive program in association with a user device, according to an implementation described herein. In one implementation, the process of FIG. 9 may be performed by user device 110. In other implementations, some or all of the process of FIG. 9 may be performed by another device or a group of devices separate from user device 110 and/or including user device 110.

The process of FIG. 9 may include initiating a digital customer card application 302 in association with user device 110 (block 902). For example, user device 110 may receive an initial input from the user to start the digital customer card application 302.

User device 110 may receive customer profile information input by the user (block 904). The customer profile information may include a name, residence address, email address, telephone number, and, in some instances, a home network MAC address associated with user device 110 that may be included in order to receive location based services. The user may input the customer profile information in response to a prompt provided in customer GUI 304.

User device 110 may present a browsable list of available retailers (block 906). The browsable list of retailers may include a digital listing (of available retailers) that may be searched/scrolled in a display of user device 110. The user may select to participate in a customer incentive program for one or more of the available retailers by selecting the retailers from the browsable list (block 908).

At block 910, user device 110 may upload the customer profile information in association with a list of selected retailers to customer incentive management system 140, in a similar manner as described at block 810 of process 800 described with respect to FIG. 8. If the customer has already enrolled in the general customer incentive program, user may provide an indication for the customer profile information to be shared with the retailers in the list of selected retailers.

User device 110 may receive customer incentive program information for the selected retailers from customer incentive management system 140 (block 912). The customer incentive program information may include a customer incentive program user identifier, such as a customer barcode. The customer incentive program information may also include digital images associated with the retailer and/or the customer incentive program, and terms and conditions of the customer incentive program.

At block 914, user device 110 may provide the customer profile information associated with the user at a transaction location. For example, the user may select the retailer in digital customer card application 302 and position user device 110 so that a scanner associated with a business device 120 may scan a presented image in a GUI of user device 110.

Systems and/or methods described herein may implement a cloud based customer incentive program. The method provides targeted advertisements to customers accurately and effectively. The cost of manufacturing (from the retailer's perspective) and carrying (from the customer's perspective) physical reward cards is reduced or eliminated. A single application may be used in order to participate in a customer incentive program with multiple retailers.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIGS. 8-9, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions of the invention may be implemented as a “component” or “system” that performs one or more functions. These components/systems may include hardware, such as a processor, an ASIC, or a FPGA, or a combination of hardware and software. No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

1. A computer-implemented method comprising:
receiving, at a third party network location, a first business profile from a first business partner, wherein the first business profile includes a first customer incentive program identifier that identifies the first business partner and a customer incentive program provided by the first business partner;
receiving a second business profile from a second business partner, wherein the second business profile includes a second customer incentive program identifier that identifies the second business partner and a customer incentive program provided by the second business partner;
adding, by a processing device, the first business partner and the second business partner to a list of available retailers;
receiving, from a user device, customer profile information for a customer and at least one selected retailer from the list of available retailers;
storing a customer profile that includes the customer profile information in association with the at least one selected retailer; and
sending a customer incentive program user identifier associated with each of the at least one selected retailer to the user device, wherein the user device is operable to present the customer incentive program user identifier to a business device and wherein the business device is operable to identify the customer in association with a particular account and to allow the customer to participate in a customer incentive program provided by the at least one selected retailer based on the customer incentive program user identifier.

2. The computer-implemented method of claim 1, wherein receiving the first business profile information further comprises:
receiving an incentive protocol for the customer incentives program associated with the first business partner, wherein the incentive protocol identifies a process for assigning rewards based on the customer incentive program;
receiving an indication of a transaction by the customer that qualifies for the customer incentives program associated with the first business partner; and
implementing the incentive protocol for the customer incentives program associated with the first business partner.

3. The computer-implemented method of claim 1, further comprising:
receiving an update to the customer profile.

4. The computer-implemented method of claim 3, further comprising:
sending the update to the customer profile to each retailer associated with the customer profile.

5. The computer-implemented method of claim 1, wherein the customer profile includes one or more of a name, residence address, or an email address associated with a customer.

6. The computer-implemented method of claim 5, wherein the customer profile further includes a home network media access control address.

7. A computer-implemented method comprising:
initiating, at a user device, a digital customer card application, wherein the digital customer card application provides client-side support for a customer incentive management system that manages a customer incentive program for a plurality of retailers;
receiving customer profile information associated with a customer account for a customer;
presenting a browsable list of available retailers from a device associated with a customer incentive program;
receiving a selection of one or more of the available retailers;
sending the customer profile and information identifying the selected one or more retailers to the customer incentive management system;
receiving at least one customer incentive program user identifier associated with each of the one or more selected retailers and the customer account;
receiving, at the user device, a selection of a particular retailer of the one or more selected retailers;
identifying a particular customer incentive program user identifier associated with the particular retailer among the received at least one customer incentive program user identifier associated with each of the one or more selected retailers and the customer account; and
presenting the particular customer incentive program user identifier in a format that is receivable by a business device, wherein the business device is operable to identify the customer in association with the customer account and the customer incentive program for the particular retailer.

8. The computer-implemented method of claim 7, wherein the particular customer incentive program user identifier further comprises:
one or more of a customer barcode, a digital image associated with the particular retailer, or a digital image associated with the customer incentive program for the particular retailer.

9. The computer-implemented method of claim 8, wherein the digital image associated with the customer incentive program for the particular retailer further comprises:
an image that indicates a particular level of available incentives associated with the user; and
wherein different levels of privileges are assigned to the user based on presentation of the image that indicates the particular level.

10. (canceled)

11. The computer-implemented method of claim 7, further comprising:
storing the list of selected one or more retailers and associated customer incentive program information.

12. A device comprising:
a memory to store a plurality of instructions; and
a processor configured to execute instructions in the memory to:
receive, at a third party network location, a first business profile from a first business partner, wherein the first business profile includes a first customer incentive program identifier that identifies the first business partner and a customer incentive program provided by the first business partner;
include the first business partner in a list of available retailers;
receive, from a user device, customer profile information for a customer and at least one selected retailer from the list of available retailers;
store a customer profile that includes the customer profile information in association with the at least one selected retailer; and
send a customer incentive program user identifier associated with each of the at least one selected retailer to the user device, wherein the user device is operable to present the customer incentive program user identifier to a business device and wherein the business device is operable to identify the customer in association with a particular account and to allow the customer to participate in a customer incentive program provided by the at least one selected retailer.

13. The device of claim 12, wherein the processor is further configured to:
receive an incentive protocol for the customer incentives program associated with the first business partner, wherein the incentive protocol identifies a process for assigning rewards based on the customer incentive program;
receive an indication of a transaction by the customer that qualifies for the customer incentives program associated with the first business partner; and
implement the incentive protocol for the customer incentives program associated with the first business partner.

14. The device of claim 12, wherein the processor is further configured to:
receive an update to the customer profile.

15. The device of claim 12, wherein the processor is further configured to:
identify contact information for each retailer associated with the customer profile; and
send the update to the customer profile to each retailer associated with the customer profile.

16. The device of claim 12, wherein the customer profile includes one or more of a name, residence address, or an email address associated with a customer.

17. The device of claim 16, wherein the customer profile further includes a home network media access control address.

18. A non-transitory computer-readable medium including instructions to be executed by a processor, the instructions including one or more instructions, when executed by the processor, for causing the processor to:
receive, at a third party network location, a first business profile from a first business partner, wherein the first business profile includes a first customer incentive program identifier that identifies the first business partner and a customer incentive program provided by the first business partner;
include the first business partner and the second business partner in a list of available retailers;
receive, from a user device, customer profile information for a customer and at least one selected retailer from the list of available retailers;
store a customer profile that includes the customer profile information in association with the at least one selected retailer; and
send a customer incentive program user identifier associated with each of the at least one selected retailer to the user device, wherein the user device is operable to present the customer incentive program user identifier to a business device and wherein the business device is operable to identify the customer in association with a particular account and to allow the customer to participate in a customer incentive program provided by the at least one selected retailer.

19. The non-transitory computer-readable medium of claim 18, further comprising instructions, when executed by the processor, for causing the processor to:
receive an incentive protocol for the customer incentives program associated with the first business partner, wherein the incentive protocol identifies a process for assigning rewards based on the customer incentive program;
receive an indication of a transaction by the customer that qualifies for the customer incentives program associated with the first business partner; and
implement the incentive protocol for the customer incentives program associated with the first business partner.

20. The non-transitory computer-readable medium of claim 18, further comprising instructions, when executed by the processor, for causing the processor to:
receive an update to the customer profile; and
send the update to the customer profile to each retailer associated with the customer profile.
